(19) United States
(12) Patent Application Publication
(10) Pub. No.: US 2025/0167926 A1
(43) Pub. Date: May 22, 2025

(54) METHODS AND APPARATUSES FOR DETERMINING NACK-ONLY BASED HARQ-ACK CODEBOOK

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 18/839,344

(22) PCT Filed: Apr. 24, 2022
(86) PCT No.: PCT/CN2022/088737

§ 371 Date: Aug. 16, 2024

(51) Int. Cl. H04L 1/1812; H04L 1/1829

(52) U.S. Cl. CPC H04L 1/1812; H04L 1/1861

(57) ABSTRACT

The present application relates to methods and apparatuses for determining negative acknowledgment (NACK) only based hybrid automatic repeat request (HARQ) acknowledgement (ACK) codebook. One embodiment of the present disclosure provides a user equipment (UE), which includes: a transceiver; and a processor coupled with the transceiver and configured to: receive, with the transceiver, a plurality of physical downlink shared channel (PDSCH) transmissions; determine a HARQ-ACK feedback combination including HARQ-ACK information bits for the plurality of PDSCH transmissions, wherein each HARQ-ACK information bit is associated with one of the plurality of PDSCH transmissions; determine a physical uplink control channel (PUCCH) resource based on the HARQ-ACK feedback combination in response to at least one PDSCH transmission of the plurality of PDSCH transmissions being incorrectly decoded; and perform, with the transceiver, a PUCCH transmission with the PUCCH resource.

### TECHNICAL FIELD

The present disclosure relates to wireless communication technology, and more particularly, to methods and apparatuses for determining negative acknowledgment (NACK) only based hybrid automatic repeat request (HARQ) acknowledgement (ACK) codebook for, e.g., multicast and broadcast services (MBS) physical downlink shared channel (PDSCH).

### BACKGROUND OF THE INVENTION

HARQ-ACK feedbacks from user equipments (UEs) corresponding to a downlink multicast transmission are essential for a multicast service in order to satisfy the quality of service (QoS) requirement thereof, e.g., reliability. A physical uplink control channel (PUCCH) resource may be shared by a group of UEs for transmitting NACK-only based HARQ-ACK feedback. NACK-only based HARQ-ACK feedback can minimize the PUCCH resource overhead since only one PUCCH resource for the NACK transmission is required for the group of UEs.

For a UE that receives multiple PDSCH transmissions for one or more MBS services, if NACK-only based HARQ-ACK feedback is configured, the UE needs to determine a HARQ-ACK codebook when the corresponding HARQ-ACK feedbacks for the multiple PDSCH transmissions are to be transmitted in the same slot. Moreover, the UE may also need to multiplex the multiple NACK-only based HARQ-ACK feedbacks in one HARQ-ACK codebook.

Therefore, it is needed to provide solutions for determining the NACK-only based HARQ-ACK codebook.

### SUMMARY

One embodiment of the present disclosure provides a UE, which includes: a transceiver; and a processor coupled with the transceiver and configured to: receive, with the transceiver, a plurality of PDSCH transmissions; determine a HARQ-ACK feedback combination including HARQ-ACK information bits for the plurality of PDSCH transmissions, wherein each HARQ-ACK information bit is associated with one of the plurality of PDSCH transmissions; determine a PUCCH resource based on the HARQ-ACK feedback combination in response to at least one PDSCH transmission of the plurality of PDSCH transmissions being incorrectly decoded; and perform, with the transceiver, a PUCCH transmission with the PUCCH resource.

In some embodiments, each PDSCH transmission of the plurality of PDSCH transmissions is associated with a HARQ process number (HPN), and the HARQ-ACK information bits included in the HARQ-ACK feedback combination is ordered based on associated HPNs of respective PDSCH transmissions.

In some embodiments, each PDSCH transmission of the plurality of PDSCH transmissions is associated with a counter downlink assignment indicator (DAI) value which is updated across multicast service(s) associated with the plurality of PDSCH transmissions, and the HARQ-ACK information bits included in the HARQ-ACK feedback combination are ordered based on the associated counter DAI values of respective PDSCH transmissions.

In some embodiments, the counter DAI value is updated in order of group-common radio network temporary identifier (G-RNTI) value(s) associated with the multicast service(s) and in time order for a same multicast service.

In some embodiments, each PDSCH transmission of the plurality of PDSCH transmissions is associated with a total DAI value which is updated across multicast service(s) associated with the plurality of PDSCH transmissions and a counter DAI value which is updated per multicast service, and the HARQ-ACK information bits included in the HARQ-ACK feedback combination are ordered based on G-RNTI value(s) associated with the multicast service(s) and the associated counter DAI values of respective PDSCH transmissions for a same multicast service.

In some embodiments, the total DAI value is updated in order of G-RNTI value(s) associated with the multicast service(s) and in time order for a same multicast service.

In some embodiments, a size of the HARQ-ACK feedback combination is determined based on a last total DAI value among total DAI values associated with the plurality of PDSCH transmissions.

In some embodiments, the HARQ-ACK feedback combination includes a number of sub-combinations, each sub-combination includes one or more HARQ-ACK information bits for PDSCH transmission(s) associated with a same multicast service, and the number of sub-combinations is determined based on the number of G-RNTIs associated with the multicast service(s) associated with the plurality of PDSCH transmissions and the sub-combinations are ordered based on G-RNTI value(s) associated with respective multicast service(s).

In some embodiments, the processor is further configured to: align a total number of HARQ-ACK information bits for a sub-combination to a configured size by performing HARQ-ACK padding or HARQ-ACK bundling.

In some embodiments, the PUCCH resource is determined based on a mapping table including a relation between the HARQ-ACK feedback combination and a PUCCH resource index associated with the PUCCH resource.

In some embodiments, PUCCH resources associated with different PUCCH resource indexes in the mapping table are orthogonal to each other.

In some embodiments, a total number of PUCCH resources indicated by the mapping table is determined based on at least one of the following: a maximum number of HARQ-ACK information bits included in a HARQ-ACK feedback combination; a PUCCH format; or a total number of bits carried by the PUCCH format.

In some embodiments, the PUCCH resource includes a PUCCH sequence in the case that the PUCCH transmission is performed with a first PUCCH format, or one or two bits are transmitted on the PUCCH resource in the case that the PUCCH transmission is performed with a second PUCCH format.

In some embodiments, the processor is further configured to: perform spatial bundling to generate a single HARQ-ACK information bit for a PDSCH transmission of the plurality of PDSCH transmissions in response to two code words being carried on the PDSCH transmission.

In some embodiments, the PUCCH resource is determined from a set of PUCCH resources configured by radio resource control (RRC) signaling.

Another embodiment of the present disclosure provides a base station (BS), which includes: a transceiver; and a processor coupled with the transceiver and configured to: transmit, to a group of UEs and with the transceiver, a plurality of PDSCH transmissions; receive, from one or multiple UEs of the group of UEs, one or multiple PUCCH transmissions on PUCCH resource(s) within a set of PUCCH resources, wherein each PUCCH transmission carries a HARQ-ACK feedback combination for the plurality of PDSCH transmissions; and determine each HARQ-ACK feedback combination based on the one or multiple PUCCH transmissions on the PUCCH resource(s) and a mapping table, wherein the mapping table defines relations between a set of HARQ-ACK feedback combinations and the set of PUCCH resources.

In some embodiments, each PDSCH transmission of the plurality of PDSCH transmissions is associated with an HPN, and HARQ-ACK information bits included in the HARQ-ACK feedback combination is ordered based on associated HPNs of respective PDSCH transmissions.

In some embodiments, each PDSCH transmission of the plurality of PDSCH transmissions is associated with a counter DAI value which is updated across multicast service(s) associated with the plurality of PDSCH transmissions, and HARQ-ACK information bits included in the HARQ-ACK feedback combination are ordered based on the associated counter DAI values of respective PDSCH transmissions.

In some embodiments, the counter DAI value is updated in order of G-RNTI value(s) associated with the multicast service(s) and in time order for a same multicast service.

In some embodiments, each PDSCH transmission of the plurality of PDSCH transmissions is associated with a total DAI value which is updated across multicast service(s) associated with the plurality of PDSCH transmissions and a counter DAI value which is updated per multicast service, and HARQ-ACK information bits included in the HARQ-ACK feedback combination are ordered based on G-RNTI value(s) associated with the multicast service(s) and the associated counter DAI values of respective PDSCH transmissions for a same multicast service.

In some embodiments, the total DAI value is updated in order of G-RNTI value(s) associated with the multicast service(s) and in time order for a same multicast service.

In some embodiments, a size of the HARQ-ACK feedback combination is determined based on a last total DAI value among total DAI values associated with the plurality of PDSCH transmissions.

In some embodiments, the HARQ-ACK feedback combination includes a number of sub-combinations, each sub-combination includes one or more HARQ-ACK information bits for PDSCH transmission(s) associated with a same multicast service, and the number of sub-combinations is determined based on the number of G-RNTIs associated with the multicast service(s) associated with the plurality of PDSCH transmissions and the sub-combinations are ordered based on G-RNTI value(s) associated with respective multicast service(s).

In some embodiments, PUCCH resources in the set of PUCCH resources are orthogonal to each other.

In some embodiments, a total number of PUCCH resources included in the set of PUCCH resources indicated by the mapping table is determined based on at least one of the following: a maximum number of HARQ-ACK information bits included in a HARQ-ACK feedback combination; a PUCCH format; or a total number of bits carried by the PUCCH format.

In some embodiments, each PUCCH resource includes a PUCCH sequence in the case that the one or multiple PUCCH transmissions are performed with a first PUCCH format, or one or two bits are received on each PUCCH resource in the case that the one or multiple PUCCH transmissions are performed with a second PUCCH format.

In some embodiments, the set of PUCCH resources is configured to the group of UEs by RRC signaling.

Still another embodiment of the present disclosure provides a method performed by a UE, which includes: receiving a plurality of PDSCH transmissions; determining a HARQ-ACK feedback combination including HARQ-ACK information bits for the plurality of PDSCH transmissions, wherein each HARQ-ACK information bit is associated with one of the plurality of PDSCH transmissions; determining a PUCCH resource based on the HARQ-ACK feedback combination in response to at least one PDSCH transmission of the plurality of PDSCH transmissions being incorrectly decoded; and performing a PUCCH transmission with the PUCCH resource.

Still another embodiment of the present disclosure provides a method performed by a BS, which includes: transmitting, to a group of UEs, a plurality of PDSCH transmissions; receiving, from one or multiple UEs of the group of UEs, one or multiple PUCCH transmissions on PUCCH resource(s) within a set of PUCCH resources, wherein each PUCCH transmission carries a HARQ-ACK feedback combination for the plurality of PDSCHs; and determining each HARQ-ACK feedback combination based on the one or multiple PUCCH transmissions on the PUCCH resource(s) and a mapping table, wherein the mapping table defines relations between a set of HARQ-ACK feedback combinations and the set of PUCCH resources.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system in accordance with some embodiments of the present disclosure.

FIG. 2 illustrates exemplary multiple NACK-only based HARQ-ACK feedbacks to be transmitted in the same slot according to some embodiments of the present disclosure.

FIG. 3 illustrates an exemplary method for generating a HARQ-ACK feedback combination according to some embodiments of the present disclosure.

FIG. 4 illustrates another exemplary method for generating a HARQ-ACK feedback combination according to some embodiments of the present disclosure.

FIG. 5 illustrates a flowchart of an exemplary method performed by a UE for NACK-only based HARQ-ACK feedback according to some embodiments of the present disclosure.

FIG. 6 illustrates a flowchart of an exemplary method performed by a BS for NACK-only based HARQ-ACK feedback according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G new radio (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

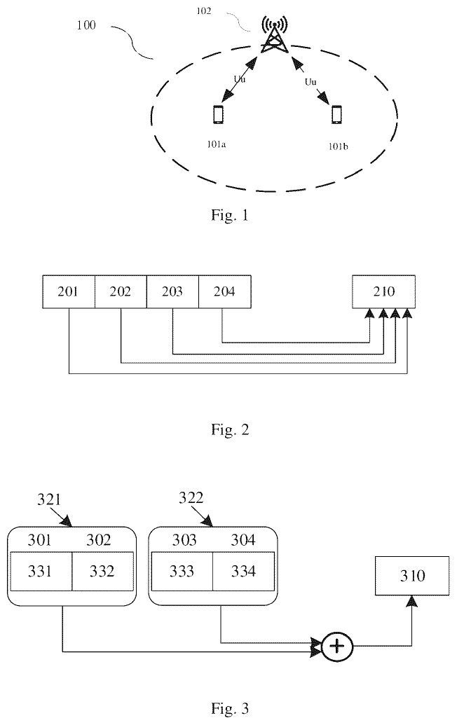

FIG. 1 illustrates a schematic diagram of an exemplary wireless communication system 100 in accordance with some embodiments of the present disclosure.

As shown in FIG. 1, the wireless communication system 100 may include at least one UE (e.g., UE 101a and UE 101b, collectively referred to as UEs 101) and at least one BS (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 may include wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BS 102. The BS 102 may communicate with the UE(s) 101 via Uu interface. For example, the BS 102 may transmit downlink (DL) communication signals to the UE(s) 101, and may receive uplink (UL) communication signals from the UE(s) 101.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, the BS 102 may transmit data using an orthogonal frequency division multiplexing (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums via a Uu interface, whereas in some other embodiments, the BS 102 and UE(s) 101 may communicate over unlicensed spectrums. The present disclosure is not intended to be limited to the implementation of any particular wireless communication system architecture or protocol.

For MBS, a group-common RNTI, e.g., G-RNTI, is introduced so that a UE can differentiate the downlink control information (DCI) scheduling MBS PDSCH from the DCI scheduling unicast PDSCH. In detail, the cyclic redundancy check (CRC) of the DCI scheduling an MBS PDSCH is scrambled by the G-RNTI and the scheduled group-common PDSCH carrying MBS is scrambled by the G-RNTI.

As stated above, a UE receiving multiple PDSCH transmissions for one or more MBS services may need to multiplex multiple NACK-only based HARQ-ACK feedbacks for the multiple PDSCH transmissions in one HARQ-ACK codebook. Regarding multiplexing multiple NACK-only based HARQ-ACK feedbacks in one PUCCH, RAN1 #108 reach the following agreements among others:
Alt4: Define combination of NACK-only which corresponds to a specific sequence or a PUCCH transmission.
   define up to 15 orthogonal PUCCH resources to select from according to combinations of up to 4 transport blocks (TBs) with NACK-only feedback,
      FFS: The PUCCH slot for the transmission is based on the K1 in the “last DCI” scheduling multicast.
      FFS: The PUCCH resource for the transmission is from PUCCH-config configured for NACK-only based feedback according to the mapping between number of TBs with PUCCH resource identity (ID).
         FFS mapping details.
         How to determine the number of TBs is discussed separately, e.g., Type-1-like and/or Type-2-like codebook.
      FFS: whether this applies to a single G-RNTI or multiple G-RNTIs
   Alt4 is not supported for more than 4 TBs

According to the above agreements, for multiplexing multiple NACK-only based feedbacks in one PUCCH, a BS needs to define up to 15 orthogonal PUCCH resources for a UE to select one PUCCH resource according to combinations of up to 4 TBs with NACK-only feedback. A mapping from NACK-only based feedback for up to 4 TBs to a specific PUCCH resource is needed so that both the BS and the UE have the same understanding on the HARQ-ACK feedback based on the specific PUCCH resource.

FIG. 2 illustrates exemplary multiple NACK-only based HARQ-ACK feedbacks to be transmitted in the same slot according to some embodiments of the present disclosure.

In FIG. 2, a DCI format, e.g., DCI format 4_1 or DCI format 4_2 as defined in 3GPP standard documents, may schedule four PDSCHs, e.g., PDSCH 201, PDSCH 202, PDSCH 203, and PDSCH 204. Each PDSCH may carry one transport block (TB). HARQ-ACK feedbacks respectively corresponding to the PDSCH 201, the PDSCH 202, the PDSCH 203, and the PDSCH 204 are indicated to be transmitted in the same UL slot 210.

A UE may correctly decode or incorrectly decode any of the TBs carried by the PDSCH 201, the PDSCH 202, the PDSCH 203, and the PDSCH 204. For example, a decoding status of “ACK” may indicate that a corresponding TB is correctly decoded, while a decoding status of “NACK” may indicate that a corresponding TB is incorrectly decoded. Accordingly, a decoding status combination (also referred to as HARQ-ACK feedback combination) consisting of four decoding statuses (also referred to as HARQ-ACK information bits) may jointly indicate the decoding statuses of the four TBs (e.g., TB1, TB2, TB3, and TB4) respectively carried by the PDSCH 201, the PDSCH 202, the PDSCH 203, and the PDSCH 204. The decoding statuses of the four TBs may form the following decoding status combinations (e.g., the decoding statuses in each decoding status combination may correspond to TB1, TB2, TB3, and TB4 in order):
1) (ACK, ACK, ACK, ACK);
2) (ACK, ACK, ACK, NACK);
3) (ACK, ACK, NACK, ACK);
4) (ACK, ACK, NACK, NACK);
5) (ACK, NACK, ACK, ACK);
6) (ACK, NACK, ACK, NACK);
7) (ACK, NACK, NACK, ACK);
8) (ACK, NACK, NACK, NACK);
9) (NACK, ACK, ACK, ACK);
10) (NACK, ACK, ACK, NACK);
11) (NACK, ACK, NACK, ACK);
12) (NACK, ACK, NACK, NACK);
13) (NACK, NACK, ACK, ACK);
14) (NACK, NACK, ACK, NACK);
15) (NACK, NACK, NACK, ACK); and
16) (NACK, NACK, NACK, NACK).

Among the above 16 decoding status combinations, there is no “NACK” in decoding status combination 1), which means that all the four TBs are correctly decoded. In the case that the UE is configured with NACK-only based HARQ-ACK feedback, the UE does not need to transmit a HARQ-ACK feedback corresponding to the decoding status combination 1) to the BS. Accordingly, when NACK-only based HARQ-ACK feedback is configured, up to 15 possible decoding status combinations need to be fed back to the BS.

In some embodiments, the UE may be configured with up to 15 PUCCH resources for multiplexing NACK-only based HARQ-ACK feedbacks for the 4 TBs or for the 4 PDSCHs. The 15 PUCCH resources may be indexed as P0, P1, P2, . . . , P14, respectively. The 15 PUCCH resources may be orthogonal to each other. Each PUCCH resource may correspond to one of the 15 decoding status combinations. The following Table 1 is an exemplary mapping table for the decoding statuses of the four TBs to a specific PUCCH resource.

TABLE 1

| No. | Decoding status combination | PUCCH resource index |
|---|---|---|
| 1 | (ACK, ACK, ACK, ACK) | not transmitted |
| 2 | (ACK, ACK, ACK, NACK) | P0 |
| 3 | (ACK, ACK, NACK, ACK) | P1 |
| 4 | (ACK, ACK, NACK, NACK) | P2 |
| 5 | (ACK, NACK, ACK, ACK) | P3 |
| 6 | (ACK, NACK, ACK, NACK) | P4 |
| 7 | (ACK, NACK, NACK, ACK) | P5 |
| 8 | (ACK, NACK, NACK, NACK) | P6 |
| 9 | (NACK, ACK, ACK, ACK) | P7 |
| 10 | (NACK, ACK, ACK, NACK) | P8 |
| 11 | (NACK, ACK, NACK, ACK) | P9 |
| 12 | (NACK, ACK, NACK, NACK) | P10 |
| 13 | (NACK, NACK, ACK, ACK) | P11 |
| 14 | (NACK, NACK, ACK, NACK) | P12 |
| 15 | (NACK, NACK, NACK, ACK) | P13 |
| 16 | (NACK, NACK, NACK, NACK) | P14 |

In this way, the UE may transmit a PUCCH transmission with one of the 15 PUCCH resources which corresponds to the decoding statuses of the 4 TBs.

However, more PUCCH resources are needed when a UE is configured with multiple G-RNTIs. When the UE is configured with one G-RNTI, a maximum number of 15 PUCCH resources are needed to correspond to HARQ-ACK feedback combinations for up to 4 TBs so that the mapping between PUCCH resources and HARQ-ACK feedback combinations can be one-to-one. When the UE is configured with more than one G-RNTI, for example, two G-RNTIs, there are a total of 32 HARQ-ACK feedback combinations for up to 4 TBs per G-RNTI. Then, a maximum number of 31 PUCCH resources are required to correspond to all HARQ-ACK feedback combinations except the HARQ-ACK feedback combination with all “ACKs.” More PUCCH resources are explosively required when the UE is configured with more G-RNTIs.

Furthermore, another issue is how to determine the number of TBs according to Type-1 HARQ-ACK codebook (e.g., for semi-persistent scheduling) or Type-2 HARQ-ACK codebook (e.g., for dynamic scheduling). Type-1 HARQ-ACK codebook leads to too much overhead, while NACK-only based HARQ-ACK feedback intends to reduce the overhead. That is, Type-1 HARQ-ACK codebook may not be suitable for NACK-only based HARQ-ACK feedback. Type-2 HARQ-ACK codebook can minimize the HARQ-ACK feedback overhead, but the problem of DCI missing may lead to a wrong HARQ-ACK codebook, especially considering that the DAI included in the DCI is updated separately for one G-RNTI (i.e., the DAI is updated within one multicast service). Accordingly, it is needed to provide solutions to guarantee both a UE and a BS have the same understanding on the HARQ-ACK codebook for multiple NACK-only based HARQ-ACK feedbacks. Furthermore, how to configure the PUCCH resource for NACK-only based HARQ-ACK feedback is also needed to be addressed.

In the present disclosure, some solutions are proposed to solve the above issues.

In the present disclosure, a UE is configured with NACK-only based HARQ-ACK feedback for a plurality of PDSCH transmissions from a BS. That is, the UE only transmits HARQ-ACK feedback when at least one HARQ-ACK information bit associated with at least one PDSCH transmission is NACK. When the UE correctly decodes all the PDSCH transmissions, or correctly decodes all the TBs carried by the PDSCH transmissions, the UE may not need to transmit any HARQ-ACK feedback. Correspondingly, the BS may know that a UE has correctly decoded all the PDSCH transmissions when the BS does not receive any HARQ-ACK feedback from the UE.

Several solutions for generating a NACK-only based HARQ-ACK codebook as well as mapping resource(s) for transmitting NACK-only based HARQ-ACK feedback are proposed for NR MBS.

### Solution 1

In solution 1, a set of HARQ processes is predefined for transmitting one or more multicast services and/or one or more unicast services. Each HARQ process has a corresponding HPN. Whether a HARQ process of the set of HARQ processes is used for a unicast service or for a multicast service is fully dependent on the scheduling of the BS. Each multicast service is configured with a specific G-RNTI for scrambling CRC of multicast DCI formats and multicast PDSCHs.

After receiving PDSCH transmissions that carry the one or more multicast services and/or one or more unicast services, a UE may decode these PDSCH transmissions, where some PDSCH transmissions may be correctly decoded, while others may not. Each PDSCH is associated with a HARQ process of the set of HARQ processes. In other words, each PDSCH is associated with an HPN.

The UE may generate or determine a HARQ-ACK feedback combination or a HARQ-ACK codebook, which includes HARQ-ACK information bits for the set of HARQ processes (i.e., HARQ-ACK information bits for the associated PDSCH transmissions). In some embodiments, the HARQ-ACK feedback combination may only include the HARQ-ACK information bits for the HARQ processes used for multicast services. In some other embodiments, the HARQ-ACK feedback combination may include the HARQ-ACK information bits for each HARQ process in the set of the HARQ processes, regardless whether the HARQ process is used for a multicast service or a unicast service.

The HARQ-ACK information bits in the HARQ-ACK feedback combination may be ordered according to the associated HPNs, e.g., in ascending order of HPNs. For instance, assuming that the total number of HARQ processes is A, and the HPNs thereof are n₁, n₂, . . . , n_{A} respectively, where n₁<n₂< . . . <n_{A}, the HARQ-ACK information bits for the HARQ processes may be arranged as follows:
1) the HARQ-ACK information bit associated with HARQ process n₁, which may be denoted with x₁, is arranged at the 1^{st} location of the HARQ-ACK feedback combination;
2) the HARQ-ACK information bit associated with HARQ process n₂, which may be denoted with x₂, is arranged at the 2^{nd} location of the HARQ-ACK feedback combination; and
   . . . .
A) the HARQ-ACK information bit associated with HARQ process n_{A}, which may be denoted with x_{A}, is arranged at the A^{th} location of the HARQ-ACK feedback combination.

Accordingly, the HARQ-ACK feedback combination includes the HARQ-ACK information bits for the A HARQ processes, which may be represented as (x₁, x₂, . . . , x_{A}). In some other embodiments, the HARQ-ACK information bits in the HARQ-ACK feedback combination may be ordered in descending order of HPNs, e.g., (x_{A}, x_{A-1}, . . . , x₁).

Each HARQ-ACK information bit may indicate one of two decoding statuses, i.e., either “ACK” or “NACK.” Accordingly, for the HARQ-ACK feedback combination including a maximum number of A HARQ-ACK information bits, the total number of possible HARQ-ACK feedback combinations is 2^{A}, wherein one HARQ-ACK feedback combination with all HARQ-ACK information bits being “ACK” does not need to be indicated to the BS while the remaining 2^{A}−1 HARQ-ACK feedback combinations need to be indicated.

In order to indicate any one of the 2^{A}−1 HARQ-ACK feedback combinations to the BS, a set of PUCCH resources may be configured by RRC signaling for the set of HARQ processes. The mapping between the HARQ-ACK feedback combinations and the set of PUCCH resources will be described later.

When a maximum of two code words can be carried on one PDSCH, spatial bundling may be performed to generate a single HARQ-ACK information bit for each HARQ process within the set of HARQ processes.

In solution 1, the HARQ-ACK feedback combination is mainly based on HPN, therefore it is applicable to the case when one or multiple multicast services are configured for a UE.

### Solution 2

A UE may be configured with NACK-only based HARQ-ACK feedback for one or more multicast services, wherein each multicast service is configured with a specific G-RNTI for scrambling CRC of multicast DCI formats and multicast PDSCHs. The DCI format scheduling a PDSCH may include a counter DAI which is updated across all the one or more multicast services in the order of at least one of the associated G-RNTI value or the PDCCH monitoring occasions. More specifically, for different multicast services, the counter DAI is updated in ascending order of G-RNTI values; for the same multicast service, the counter DAI is updated in time order for the PDCCH monitoring occasions. In some examples, the counter DAI may be updated only based in time order from one PDCCH monitoring occasion to next across all the configured one or more multicast services.

FIG. 3 illustrates an exemplary method for generating a HARQ-ACK feedback combination according to some embodiments of the present disclosure.

In FIG. 3, the UE is configured with NACK-only based HARQ-ACK feedback for two multicast services, e.g., multicast service 321 and multicast service 322. The corresponding HARQ-ACK feedbacks for the two multicast services is indicated to be transmitted in the same UL slot, e.g., slot 310. Multicast service 321 includes two PDSCH transmissions, e.g., PDSCH 301 and PDSCH 302, and multicast service 322 includes two PDSCH transmissions, e.g., PDSCH 303 and PDSCH 304. Each PDSCH transmission is associated with a counter DAI included in the DCI scheduling the PDSCH transmission. The counter DAIs are updated across the two multicast services in order of associated G-RNTI values or PDCCH monitoring occasions. For example, it is assumed that multicast service 321 has a smaller G-RNTI value than multicast service 322, thus the counter DAIs associated with the PDSCH transmissions in multicast service 321 are updated before those in multicast service 322. For the PDSCH transmissions with the same G-RNTI value, i.e., PDSCH transmissions associated with the same multicast service, such as PDSCH 301 and PDSCH 302, the counter DAI is updated based on the time order. Since the PDCCH monitoring occasion for PDSCH 301 is earlier than that of PDSCH 302, the counter DAI associated with PDSCH 301 is updated before that associated with PDSCH 302. For example, counter DAI 331 associated with PDSCH 301 has a value of 1, counter DAI 332 associated with PDSCH 302 has a value of 2, counter DAI 333 associated with PDSCH 303 has a value of 3, and counter DAI 334 associated with PDSCH 304 has a value of 4.

To generate a HARQ-ACK feedback combination including HARQ-ACK information bits for the one or multiple multicast services, the HARQ-ACK information bits in the HARQ-ACK feedback combination are ordered based on the values of the associated counter DAIs, such as an ascending order or descending order of the values of the counter DAIs.

Assuming that M TBs, which may be represented as TB₁, TB₂, . . . , TB_{M}, are transmitted for the one or more multicast services with NACK-only based HARQ-ACK feedback, M counter DAIs are transmitted for M PDSCH transmissions that carry the M TBs. Specifically, the values of counter DAIs associated with the M PDSCH transmissions may be represented as y₁, y₂, . . . y_{M}, where y₁<y₂< . . . <y_{M}.

The HARQ-ACK information bits in the HARQ-ACK feedback combination may be ordered according to the ascending order of the counter DAIs associated with the PDSCH transmissions. The HARQ-ACK information bits, e.g., a₁, a₂, . . . , a_{M}, may correspond to the PDSCH transmissions associated with the values of counter DAIs y₁, y₂, . . . y_{M} respectively. Therefore, the HARQ-ACK feedback combination may be (a₁, a₂, . . . , a_{M}).

Each HARQ-ACK information bit may indicate one of two decoding statuses, i.e., either “ACK” or “NACK.” Therefore, the total number of possible HARQ-ACK feedback combinations is 2^{M}, wherein one HARQ-ACK feedback combination with all HARQ-ACK information bits being “ACK” does not need to be indicated to the BS, while the remaining 2^{M}−1 HARQ-ACK feedback combinations need to be indicated.

In order to indicate any one of the 2^{M}−1 HARQ-ACK feedback combinations to the BS, a set of PUCCH resources may be configured by RRC signaling. The mapping between the HARQ-ACK feedback combinations and the set of PUCCH resources will be described later.

When a maximum of two code words can be carried on one PDSCH, spatial bundling may be performed to generate a single HARQ-ACK information bit for each PDSCH.

### Solution 3

A UE may be configured with NACK-only based HARQ-ACK feedback for one or more multicast services, wherein each multicast service is configured with a specific G-RNTI for scrambling CRC of multicast DCI formats and multicast PDSCHs. A total DAI may be included in the multicast DCI format for indicating the total number of transmitted multicast DCI formats for the one or multiple multicast services, and the total DAI is updated from one PDCCH monitoring occasion to next. That is, the total DAI is updated across the one or more multicast services. The DCI may also include a counter DAI which is updated only for the multicast service associated with the PDSCH scheduled by the DCI. The presence of a total DAI in a multicast DCI format may be dependent on the number of configured G-RNTIs. For example, in the case that only a single G-RNTI is configured, the multicast DCI format may not include the total DAI; in the case that two or more G-RNTIs are configured, the multicast DCI format may include the total DAI.

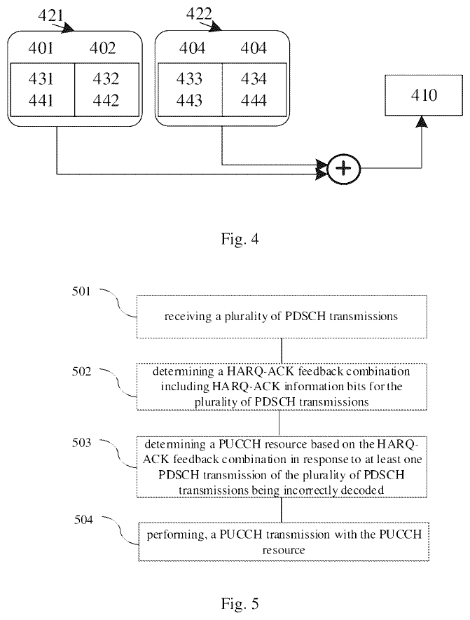

FIG. 4 illustrates an exemplary method for generating a HARQ-ACK feedback combination according to some embodiments of the present disclosure.

In FIG. 4, the UE is configured with NACK-only based HARQ-ACK feedback for two multicast services, e.g., multicast service 421 and multicast service 422. The corresponding HARQ-ACK feedbacks for the two multicast services is indicated to be transmitted in the same UL slot, e.g., slot 410. Multicast service 421 includes two PDSCH transmissions, e.g., PDSCH 401 and PDSCH 402, and multicast service 422 includes two PDSCH transmissions, e.g., PDSCH 403 and PDSCH 404. PDSCH 401 is associated with counter DAI 431 and total DAI 441 included in the DCI scheduling PDSCH 401. PDSCH 402 is associated with counter DAI 432 and total DAI 442 included in the DCI scheduling PDSCH 402. PDSCH 403 is associated with counter DAI 433 and total DAI 443 included in the DCI scheduling PDSCH 403. PDSCH 404 is associated with counter DAI 434 and total DAI 444 included in the DCI scheduling PDSCH 404.

The total DAIs are updated from one PDCCH monitoring occasion to the next PDCCH monitoring occasion. For example, the total DAI 441 associated with PDSCH 401 has a value of 1, the total DAI 442 associated with PDSCH 402 has a value of 2, the total DAI 443 associated with PDSCH 403 has a value of 3, and the total DAI 444 associated with PDSCH 404 has a value of 4. The counter DAI is updated only for the associated multicast service. For example, the counter DAI 431 associated with PDSCH 401 has a value of 1, the counter DAI 432 associated with PDSCH 402 has a value of 2, the counter DAI 433 associated with PDSCH 403 has a value of 1, and the counter DAI 434 associated with PDSCH 404 has a value of 2.

The UE may generate a HARQ-ACK feedback combination including HARQ-ACK information bits for the one or multiple multicast services, and the HARQ-ACK information bits are ordered based on G-RNTI values for different multicast services (e.g., in ascending order) and the values of the counter DAIs for the same multicast service (e.g., in ascending order). More specifically, for different multicast services, the HARQ-ACK information bits are ordered in ascending order of G-RNTI values; for the same multicast service, the HARQ-ACK information bits are ordered in ascending of the values of the counter DAIs.

The number of bits in the HARQ-ACK feedback combination is determined based on the value of the total DAI in the last multicast DCI format. For example, the value of the total DAI in the last multicast DCI format in FIG. 4 is 4, thus the number of bits in the HARQ-ACK feedback combination may be 4.

Assuming that Q TBs, which may be represented as TB₁, TB₂, . . . , TB_{Q}, are transmitted for the one or more multicast services with NACK-only based HARQ-ACK feedback, Q total DAIs and Q counter DAIs are determined for Q PDSCH transmissions that carry the Q TBs.

The HARQ-ACK information bits in the HARQ-ACK feedback combination may be ordered according to the ascending order of the G-RNTI values for different multicast services and the counter DAIs for the same multicast service. For example, the HARQ-ACK feedback combination may be (b₁, b₂, . . . , b_{Q}), where the HARQ-ACK information bits, i.e., b₁, b₂, . . . , b_{Q}, may correspond to the Q PDSCH transmissions and be ordered as described above.

Each HARQ-ACK information bit may indicate one of two decoding statuses, i.e., either “ACK” or “NACK.” Therefore, the total number of possible HARQ-ACK feedback combination is 2^{Q}, wherein one HARQ-ACK feedback combination with all HARQ-ACK information bits being “ACK” does not need to be indicated to the BS, while the remaining 2^{Q}−1 HARQ-ACK feedback combinations need to be indicated.

In order to indicate any one of the 2^{Q}−1 HARQ-ACK feedback combinations to the BS, a set of PUCCH resources may be configured by RRC signaling. The mapping between the HARQ-ACK feedback combinations and the set of PUCCH resources will be described later.

### Solution 4

A UE may be configured with NACK-only based HARQ-ACK feedback for one or more multicast services, wherein each multicast service is configured with a specific G-RNTI for scrambling CRC of multicast DCI formats and multicast PDSCHs.

In solution 4, an RRC signaling is used to configure the number of HARQ-ACK information bits for each of the one or more multicast services in a HARQ-ACK feedback combination for the one or more multicast services. That is, the RRC signaling may configure a size for a sub-combination of HARQ-ACK feedback for each multicast service.

Accordingly, the UE may generate a HARQ-ACK feedback combination including the sub-combination for each multicast service of the one or more multicast services. In the HARQ-ACK feedback combination, these sub-combinations are ordered based on G-RNTI values associated with corresponding multicast services (e.g., in ascending order).

For example, it is assumed that the total number of multicast services configured for the UE is Z, and the Z multicast services are configured with NACK-only based HARQ-ACK feedback, then RRC signaling may configure a size for the sub-combination for each of the Z multicast services.

For simplicity, denote K₀, K₁, . . . , K_{Z-1}, as the sizes for the sub-combinations for the Z multicast services respectively. Then, the size for the HARQ-ACK feedback combination for the Z multicast services, K, is equal to K₀+K₁+ . . . +K_{Z-1}, i.e., K=K₀+K₁+ . . . +K_{Z-1}. In some embodiments, the size of each of the sub-combination may be identical, thus RRC signalling overhead is saved.

In some other embodiments, for each multicast service, the number of TBs or PDSCH transmissions with NACK-only based HARQ-ACK feedback to be multiplexed in one HARQ-ACK feedback combination is configured by RRC signaling, and then the number of bits in the HARQ-ACK feedback combination is determined. The HARQ-ACK information bits in the HARQ-ACK feedback combination are ordered in a fashion similar to solution 3. For example, for different multicast services, the HARQ-ACK information bits are ordered in ascending order of G-RNTI values (i.e., the sub-combinations are ordered in ascending order of G-RNTI values); for the same multicast service, the HARQ-ACK information bits are ordered in ascending order of the counter DAIs.

For a sub-combination for a multicast service, which may be configured with a size of N_{A}, the UE may generate the HARQ-ACK information bits for the multicast service, and the number of the generated HARQ-ACK information bits may be N_{B}. In the case that N_{B} is smaller than N_{A}, the UE may perform HARQ-ACK padding, such that the size of the sub-combination is N_{A}; in the case the N_{B} is greater than N_{A}, the UE may perform HARQ-ACK bundling, e.g., performing logic AND operation among the HARQ-ACK information bits, until the number of HARQ-ACK information bits is equal to N_{A}.

In some embodiments, the size for each sub-combination is configured or predefined as one. In the case that the number of the generated HARQ-ACK information bit for a multicast service is one, the UE may consider the generated HARQ-ACK information bit as the HARQ-ACK information bit for the sub-combination; in the case that the number of the generated HARQ-ACK information bits for a multicast service is greater than one, HARQ-ACK bundling is performed to generate a single bit for the associated multicast service. In the case that the UE does not receive a PDSCH carrying a multicast service, a NACK bit may be generated for the multicast service.

Based on the sub-combinations, the UE may determine the HARQ-ACK feedback combination, and may indicate the HARQ ACK feedback combination to the BS.

In the case that the HARQ-ACK feedback combination has a size of K, the total number of possible HARQ-ACK feedback combination is 2^{K}, wherein one HARQ-ACK feedback combination with all HARQ-ACK information bits being “ACK” does not need to be indicated to the BS, while the remaining 2^{K}−1 HARQ-ACK feedback combinations need to be indicated. In order to indicate the 2^{K}−1 HARQ-ACK feedback combinations to the BS, a set of PUCCH resources may be configured by RRC signaling. The mapping between the HARQ-ACK feedback combinations and the set of PUCCH resources will be described later.

As described above, in any one of solutions 1-4, the UE may be configured with a set of PUCCH resources and may transmit a PUCCH with a PUCCH resource selected from the set of PUCCH resources to indicate a corresponding HARQ-ACK feedback combination.

The present disclosure proposes a mapping table which defines the relation or mapping between HARQ-ACK feedback combinations and the set of PUCCH resources. With the mapping table, a linkage from the HARQ-ACK information bits in a HARQ-ACK feedback combination to a specific PUCCH resource is established, and different HARQ-ACK feedback combinations may correspond to orthogonal PUCCH resources. A HARQ-ACK feedback combination may be also named as a HARQ-ACK codebook.

The UE may select a PUCCH resource from the set of PUCCH resources and perform a PUCCH transmission with the selected PUCCH resource according to the mapping table and the HARQ-ACK feedback combination. In some embodiments, PUCCH format 0 may be used for transmitting the PUCCH transmission indicating the HARQ-ACK feedback combination, and the PUCCH transmission may include a sequence. In some other embodiments, PUCCH format 1 may be used for transmitting the PUCCH transmission indicating the HARQ-ACK feedback combination, and the PUCCH transmission may carry one bit or two bits.

Regarding the mapping table defining the relations between a set of HARQ ACK feedback combinations and a set of PUCCH resources, several embodiments are proposed as follows.

It is assumed that 2^{N}−1 HARQ-ACK feedback combinations need to be indicated to a BS, for example, when solution 1 is applied, NACK-only based HARQ-ACK feedbacks for N HARQ processes are indicated to be transmitted in the same UL slot; or when any of solutions 2-4 is applied, NACK-only based HARQ-ACK feedbacks for N PDSCH transmissions are indicated to be transmitted in the same UL slot. The present disclosure proposes some embodiments for mapping the 2^{N}−1 HARQ-ACK feedback combinations to a set of PUCCH resources as follows.

### Embodiment 1

In this embodiment, a set of PUCCH resources are used for indicating the HARQ-ACK feedback combinations. The number of PUCCH resources in the set of PUCCH resources is equal to the total number of HARQ-ACK feedback combinations minus one, i.e., 2^{N}−1. The PUCCH resource indexes may be P0, P1, . . . , P(2^{N}−1), respectively. The PUCCH resources in the set of PUCCH resources are orthogonal to each other.

A mapping table including the relation between each HARQ-ACK feedback combination and each index of the PUCCH resource is defined. After the UE determines a specific HARQ-ACK feedback combination, which is one from the 2^{N}−1 HARQ-ACK feedback combinations, the UE may determine one PUCCH resource index according to the mapping table, and thus the PUCCH resource corresponding to the PUCCH resource index is determined.

For instance, it is assumed that the value of N is 4, then the total number of HARQ-ACK feedback combinations that need to be indicated is 15, and 15 PUCCH resources respectively indexed as P0, P1, P2, . . . , P14, are configured for indicating the determined HARQ-ACK feedback combination. The following Table 2 is an exemplary mapping table that may be applied:

TABLE 2

| | HARQ-ACK feedback combination | PUCCH resource index |
|---|---|---|
| 1 | (ACK, ACK, ACK, ACK) | not transmitted |
| 2 | (ACK, ACK, ACK, NACK) | P0 |
| 3 | (ACK, ACK, NACK, ACK) | P1 |
| 4 | (ACK, ACK, NACK, NACK) | P2 |
| 5 | (ACK, NACK, ACK, ACK) | P3 |
| 6 | (ACK, NACK, ACK, NACK) | P4 |
| 7 | (ACK, NACK, NACK, ACK) | P5 |
| 8 | (ACK, NACK, NACK, NACK) | P6 |
| 9 | (NACK, ACK, ACK, ACK) | P7 |
| 10 | (NACK, ACK, ACK, NACK) | P8 |
| 11 | (NACK, ACK, NACK, ACK) | P9 |
| 12 | (NACK, ACK, NACK, NACK) | P10 |
| 13 | (NACK, NACK, ACK, ACK) | P11 |
| 14 | (NACK, NACK, ACK, NACK) | P12 |
| 15 | (NACK, NACK, NACK, ACK) | P13 |
| 16 | (NACK, NACK, NACK, NACK) | P14 |

For example, when solution 1 is applied, in the case that the UE correctly decodes the PDSCH transmissions associated with the first HPN and the second HPN, and incorrectly decodes the PDSCH transmissions associated with the third HPN and the fourth HPN, the UE may determine the HARQ-ACK feedback combination as (ACK, ACK, NACK, NACK). Then, the UE may determine PUCCH resource P2 based on Table 2 and perform a PUCCH transmission with PUCCH resource P2.

When solution 2, solution 3, or solution 4 is applied, in the case that the UE correctly decodes the first and second PDSCH transmissions respectively associated with the first and second HARQ-ACK information bits, and incorrectly decodes the third and fourth PDSCH transmissions respectively associated with the third and fourth HARQ-ACK information bits, the UE may determine the HARQ-ACK feedback combination as (ACK, ACK, NACK, NACK). Then, the UE may determine PUCCH resource P2 based on Table 2 and perform a PUCCH transmission with PUCCH resource P2.

For solution 2 and solution 3, Table 2, which is used for HARQ-ACK feedback combinations associated with up to 4 TBs, may still apply while only 3 TBs are transmitted. For example, it is assumed that the HARQ-ACK feedback combination includes HARQ-ACK information bits for the four TBs (e.g., TB₁, TB₂, TB₃, TB₄) is (a₁, a₂, a₃, a₄), when only three TBs (e.g., TB₂, TB₃, and TB₄) are received, the UE may determine the PUCCH resource index among entries 2 to 8, which include all the combinations for HARQ-ACK information bits for TB₂, TB₃, and TB₄ except the case that all the three TBs are correctly decoded. Alternatively, the UE may determine the PUCCH resource index among entries 10 to 16, which also include all the combinations for HARQ-ACK information bits for TB₂, TB₃, and TB₄ except the case that all the three TBs are correctly decoded. Regarding the case that all the three TBs are correctly decoded, the UE may not transmit any feedback, and thus no PUCCH resource or PUCCH resource index is needed. In some examples, when only one, two or three TBs are received, the UE may perform HARQ-ACK padding to align the size of 4, e.g., prepending or appending ACK or NACK bit(s) to the HARQ-ACK feedback combination to align the size of 4, and then determine the PUCCH resource index among entries 1 to 16. For example, when only three TBs, e.g., TB₂, TB₃, and TB₄, are received, a NACK bit can be prepended for TB1 so that the HARQ-ACK feedback combination may be (NACK, a₂, a₃, a₄) for 4 TBs.

### Embodiment 2

In this embodiment, PUCCH format 0 is used for the PUCCH transmission, and each PUCCH resource included in the set of PUCCH resources may include a sequence. In other words, a set of PUCCH sequences are used for indicating the HARQ-ACK feedback combination. The number of sequences in the set of PUCCH sequences is equal to the total number of HARQ-ACK feedback combinations minus one, i.e., 2^{N}−1. The indexes of the PUCCH sequences may be S0, S1, . . . , S(2^{N}−1), respectively.

A mapping table including the relation between each HARQ-ACK feedback combination and each index of the PUCCH sequence is defined. After the UE determines a specific HARQ-ACK feedback combination, which is one from the 2^{N}−1 HARQ-ACK feedback combinations, the UE may determine one PUCCH sequence index according to the mapping table, and thus the PUCCH sequence corresponding to the PUCCH sequence index is determined.

For instance, it is assumed that the value of N is 4, then the total number of HARQ-ACK feedback combinations that need to be indicated is 15, and 15 PUCCH sequences respectively indexed as S0, S1, S2, . . . , S14, are configured for indicating the determined HARQ-ACK feedback combination. The following Table 3 is an exemplary mapping table that may be applied:

TABLE 3

| | HARQ-ACK feedback combination | PUCCH sequence index |
|---|---|---|
| 1 | (ACK, ACK, ACK, ACK) | — |
| 2 | (ACK, ACK, ACK, NACK) | S0 |
| 3 | (ACK, ACK, NACK, ACK) | S1 |
| 4 | (ACK, ACK, NACK, NACK) | S2 |
| 5 | (ACK, NACK, ACK, ACK) | S3 |
| 6 | (ACK, NACK, ACK, NACK) | S4 |
| 7 | (ACK, NACK, NACK, ACK) | S5 |
| 8 | (ACK, NACK, NACK, NACK) | S6 |
| 9 | (NACK, ACK, ACK, ACK) | S7 |
| 10 | (NACK, ACK, ACK, NACK) | S8 |
| 11 | (NACK, ACK, NACK, ACK) | S9 |
| 12 | (NACK, ACK, NACK, NACK) | S10 |
| 13 | (NACK, NACK, ACK, ACK) | S11 |
| 14 | (NACK, NACK, ACK, NACK) | S12 |
| 15 | (NACK, NACK, NACK, ACK) | S13 |
| 16 | (NACK, NACK, NACK, NACK) | S14 |

In the case that the determined HARQ-ACK feedback combination is (ACK, ACK, NACK, NACK), according to Table 3, the UE may determine PUCCH sequence S2, and perform a PUCCH transmission with PUCCH sequence S2 on the physical resource block (PRB) configured for PUCCH format 0 to indicate the HARQ-ACK feedback combination.

### Embodiment 3

In this embodiment, PUCCH format 1 is used for the PUCCH transmission, and each PUCCH transmission may carry one bit. The bit value may include “0” and “1.” Therefore, for each PUCCH resource, the PUCCH transmission may include the following two types: PUCCH format 1 carrying bit value “0” transmitted on the PUCCH resource; and PUCCH format 1 carrying bit value “1” transmitted on the PUCCH resource. Therefore, each PUCCH resource combined with the two bit values may indicate two HARQ-ACK feedback combinations.

Therefore, for the 2^{N}−1 HARQ-ACK feedback combinations,

$$⌈ \frac{{2}^{N} - 1}{2} ⌉$$

PUCCH resources are required for transmitting the NACK-only based HARQ-ACK feedback combination. The PUCCH resources may be indexed as P0, P1, . . .

$$P ⌈ \frac{{2}^{N} - 1}{2} ⌉ ,$$

respectively.

An exemplary mapping table for indicating the relations among the HARQ-ACK feedback combinations, the bit values, and the PUCCH resource indexes is defined. After the UE determines a specific HARQ-ACK feedback combination, which is one from the 2^{N}−1 HARQ-ACK feedback combinations, the UE may select one bit value and one PUCCH resource index according to the mapping table, and may transmit the selected bit value on the PUCCH resource corresponding to the selected PUCCH resource index to indicate the HARQ-ACK feedback combination to the BS.

For instance, it is assumed that the value of N is 4, then the total number of HARQ-ACK feedback combinations that need to be indicated is 15, and 8 PUCCH resources respectively indexed as P0, P1, P2, . . . , P7, are configured for indicating the determined HARQ-ACK feedback combination. The following Table 4A is an exemplary mapping table that may be applied:

TABLE 4A

| | HARQ-ACK feedback | | PUCCH resource |
|---|---|---|---|
| | combination | Bit value | index |
| 1 | (ACK, ACK, ACK, ACK) | — | Not transmitted |
| 2 | (ACK, ACK, ACK, NACK) | 1 | P0 |
| 3 | (ACK, ACK, NACK, ACK) | 0 | P1 |
| 4 | (ACK, ACK, NACK, NACK) | 1 | P1 |
| 5 | (ACK, NACK, ACK, ACK) | 0 | P2 |
| 6 | (ACK, NACK, ACK, NACK) | 1 | P2 |
| 7 | (ACK, NACK, NACK, ACK) | 0 | P3 |
| 8 | (ACK, NACK, NACK, NACK) | 1 | P3 |
| 9 | (NACK, ACK, ACK, ACK) | 0 | P4 |
| 10 | (NACK, ACK, ACK, NACK) | 1 | P4 |
| 11 | (NACK, ACK, NACK, ACK) | 0 | P5 |
| 12 | (NACK, ACK, NACK, NACK) | 1 | P5 |
| 13 | (NACK, NACK, ACK, ACK) | 0 | P6 |
| 14 | (NACK, NACK, ACK, NACK) | 1 | P6 |
| 15 | (NACK, NACK, NACK, ACK) | 0 | P7 |
| 16 | (NACK, NACK, NACK, NACK) | 1 | P7 |

In the case that the determined HARQ-ACK feedback combination is (ACK, ACK, NACK, NACK), according to Table 4A, the UE may determine to transmit the bit value “1” on the PUCCH resource P1 to indicate the HARQ-ACK feedback combination to the BS.

Alternatively, for the first HARQ-ACK feedback combination, i.e., (ACK, ACK, ACK, ACK), the UE may also indicate the first HARQ-ACK feedback combination to the BS. For example, the following Table 4B is an exemplary mapping table that may be applied for such case:

TABLE 4B

| | HARQ-ACK feedback | | PUCCH resource |
|---|---|---|---|
| | combination | Bit value | index |
| 1 | (ACK, ACK, ACK, ACK) | 0 | P0 |
| 2 | (ACK, ACK, ACK, NACK) | 1 | P0 |
| 3 | (ACK, ACK, NACK, ACK) | 0 | P1 |
| 4 | (ACK, ACK, NACK, NACK) | 1 | P1 |
| 5 | (ACK, NACK, ACK, ACK) | 0 | P2 |
| 6 | (ACK, NACK, ACK, NACK) | 1 | P2 |
| 7 | (ACK, NACK, NACK, ACK) | 0 | P3 |
| 8 | (ACK, NACK, NACK, NACK) | 1 | P3 |
| 9 | (NACK, ACK, ACK, ACK) | 0 | P4 |
| 10 | (NACK, ACK, ACK, NACK) | 1 | P4 |
| 11 | (NACK, ACK, NACK, ACK) | 0 | P5 |
| 12 | (NACK, ACK, NACK, NACK) | 1 | P5 |
| 13 | (NACK, NACK, ACK, ACK) | 0 | P6 |
| 14 | (NACK, NACK, ACK, NACK) | 1 | P6 |
| 15 | (NACK, NACK, NACK, ACK) | 0 | P7 |
| 16 | (NACK, NACK, NACK, NACK) | 1 | P7 |

According to Table 4B, when the determined HARQ-ACK feedback combination is (ACK, ACK, ACK, ACK), the UE may determine to transmit the bit value “0” on the PUCCH resource P0 to indicate the HARQ-ACK feedback combination to the BS.

### Embodiment 4

In this embodiment, PUCCH format 1 is used for the PUCCH transmission, and each PUCCH transmission may carry two bits. The bit value of the two bits may include “00,” “01,” “10” and “11.” Therefore, for each PUCCH resource, the PUCCH transmission may include the following four types:
1) PUCCH format 1 carrying the two-bit value of “00” transmitted on the PUCCH resource;
2) PUCCH format 1 carrying the two-bit value of “01” transmitted on the PUCCH resource;
3) PUCCH format 1 carrying the two-bit value of “10” transmitted on the PUCCH resource; and
4) PUCCH format 1 carrying the two-bit value of “11” transmitted on the PUCCH resource.

Therefore, for the 2^{N}−1 HARQ-ACK feedback combinations,

$$⌈ \frac{{2}^{N} - 1}{4} ⌉$$

PUCCH resources are required for transmitting the NACK-only based HARQ-ACK feedback combinations. The PUCCH resources may be indexed as P0, P1, . . . ,

$$P ⌈ \frac{{2}^{N} - 1}{4} ⌉ ,$$

respectively.

For instance, it is assumed that the value of N is 4, then the total number of HARQ-ACK feedback combinations that need to be indicated is 15, and 4 PUCCH resources respectively indexed as P0, P1, P2, and P3, are configured for indicating the determined HARQ-ACK feedback combination. The following Table 4C is an exemplary mapping table that may be applied for indicating the relations among the HARQ-ACK feedback combinations, the bit values, and the PUCCH resource indexes:

TABLE 4C

| | HARQ-ACK feedback | | PUCCH resource |
|---|---|---|---|
| | combination | Bit value | index |
| 1 | (ACK, ACK, ACK, ACK) | — | Not transmitted |
| 2 | (ACK, ACK, ACK, NACK) | 01 | P0 |
| 3 | (ACK, ACK, NACK, ACK) | 10 | P0 |
| 4 | (ACK, ACK, NACK, NACK) | 11 | P0 |
| 5 | (ACK, NACK, ACK, ACK) | 00 | P1 |
| 6 | (ACK, NACK, ACK, NACK) | 01 | P1 |
| 7 | (ACK, NACK, NACK, ACK) | 10 | P1 |
| 8 | (ACK, NACK, NACK, NACK) | 11 | P1 |
| 9 | (NACK, ACK, ACK, ACK) | 00 | P2 |
| 10 | (NACK, ACK, ACK, NACK) | 01 | P2 |
| 11 | (NACK, ACK, NACK, ACK) | 10 | P2 |
| 12 | (NACK, ACK, NACK, NACK) | 11 | P2 |
| 13 | (NACK, NACK, ACK, ACK) | 00 | P3 |
| 14 | (NACK, NACK, ACK, NACK) | 01 | P3 |
| 15 | (NACK, NACK, NACK, ACK) | 10 | P3 |
| 16 | (NACK, NACK, NACK, NACK) | 11 | P3 |

In the case that the determined HARQ-ACK feedback combination is (ACK, ACK, NACK, NACK), according to Table 4C, the UE may determine to transmit the bit value “11” on PUCCH resource P0 to indicate the HARQ-ACK feedback combination to the BS.

Alternatively, for the first HARQ-ACK feedback combination, i.e., (ACK, ACK, ACK, ACK), the UE may also indicate the first HARQ-ACK feedback combination to the BS. For example, the following Table 4D is an exemplary mapping table that may be applied for such case:

TABLE 4D

| | HARQ-ACK feedback | | PUCCH resource |
|---|---|---|---|
| | combination | Bit value | index |
| 1 | (ACK, ACK, ACK, ACK) | 00 | P0 |
| 2 | (ACK, ACK, ACK, NACK) | 01 | P0 |
| 3 | (ACK, ACK, NACK, ACK) | 10 | P0 |
| 4 | (ACK, ACK, NACK, NACK) | 11 | P0 |
| 5 | (ACK, NACK, ACK, ACK) | 00 | P1 |
| 6 | (ACK, NACK, ACK, NACK) | 01 | P1 |
| 7 | (ACK, NACK, NACK, ACK) | 10 | P1 |
| 8 | (ACK, NACK, NACK, NACK) | 11 | P1 |
| 9 | (NACK, ACK, ACK, ACK) | 00 | P2 |
| 10 | (NACK, ACK, ACK, NACK) | 01 | P2 |
| 11 | (NACK, ACK, NACK, ACK) | 10 | P2 |
| 12 | (NACK, ACK, NACK, NACK) | 11 | P2 |
| 13 | (NACK, NACK, ACK, ACK) | 00 | P3 |
| 14 | (NACK, NACK, ACK, NACK) | 01 | P3 |
| 15 | (NACK, NACK, NACK, ACK) | 10 | P3 |
| 16 | (NACK, NACK, NACK, NACK) | 11 | P3 |

According to Table 4D, when the determined HARQ-ACK feedback combination is (ACK, ACK, ACK, ACK), the UE may determine to transmit the bit value “00” on PUCCH resource P0 to indicate the HARQ-ACK feedback combination to the BS.

For the above solutions 1-4, at the BS side, the BS may blind detect the PUCCH transmission with each PUCCH resource of the set of PUCCH resources configured for indicating the HARQ-ACK feedback combination. Upon detection of a PUCCH transmission with a certain PUCCH resource, the BS can know the HARQ-ACK feedbacks of a UE for the associated PDSCH transmissions according to the mapping table.

The one or more multicast services may be received by a group of UEs, and different UEs may have different HARQ-ACK feedbacks for the received PDSCH transmissions carrying the one or more multicast services, so that different UEs may select different PUCCH resources according to the mapping table and respective HARQ-ACK feedbacks and transmit respective PUCCHs on the selected respective PUCCH resources. In this way, the BS may detect multiple PUCCHs within the set of PUCCH resources and retransmit those PDSCH transmissions with NACK reported by any one UE.

FIG. 5 illustrates a flowchart of an exemplary method performed by a UE (e.g., UE 101 in FIG. 1) for NACK-only based HARQ-ACK feedback according to some embodiments of the present disclosure. Details described in all of the foregoing embodiments of the present disclosure are applicable for the embodiments shown in FIG. 5.

In operation 501, the UE may receive a plurality of PDSCH transmissions. In operation 502, the UE may determine a HARQ-ACK feedback combination including HARQ-ACK information bits for the plurality of PDSCH transmissions, wherein each HARQ-ACK information bit is associated with one of the plurality of PDSCH transmissions. In operation 503, the UE may determine a PUCCH resource based on the HARQ-ACK feedback combination in response to at least one PDSCH transmission of the plurality of PDSCH transmissions being incorrectly decoded. In operation 504, the UE may perform a PUCCH transmission with the PUCCH resource.

In some embodiments, each PDSCH transmission of the plurality of PDSCH transmissions is associated with an HPN, and the HARQ-ACK information bits included in the HARQ-ACK feedback combination is ordered based on associated HPNs of respective PDSCH transmissions. For example, in solution 1, each PDSCH transmission is associated with an HPN.

In some embodiments, each PDSCH transmission of the plurality of PDSCH transmissions is associated with a counter DAI value which is updated across multicast service(s) associated with the plurality of PDSCH transmissions, and the HARQ-ACK information bits included in the HARQ-ACK feedback combination are ordered based on the associated counter DAI values of respective PDSCH transmissions. In some embodiments, the counter DAI value is updated in order of G-RNTI value(s) associated with the multicast service(s) and in time order for a same multicast service. For example, as illustrated in FIG. 3, each PDSCH transmission is associated with a counter DAI, and the counter DAI is updated across the two multicast services 321 and 322. For the same multicast service, such as multicast service 321, the counter DAI for PDSCH transmission 301 and the counter DAI for PDSCH transmission 302 are updated in time order. In some examples, the counter DAI may be updated only based in time order from one PDCCH monitoring occasion to next across all the configured one or more multicast services.

In some embodiments, each PDSCH transmission of the plurality of PDSCH transmissions is associated with a total DAI value which is updated across multicast service(s) associated with the plurality of PDSCH transmissions and a counter DAI value which is updated per multicast service, and the HARQ-ACK information bits included in the HARQ-ACK feedback combination are ordered based on G-RNTI value(s) associated with the multicast service(s) and the associated counter DAI values of respective PDSCH transmissions for a same multicast service. In some embodiments, the total DAI value is updated in order of G-RNTI value(s) associated with the multicast service(s) and in time order for a same multicast service. For example, as illustrated in FIG. 4, each PDSCH transmission is associated with a total DAI and a counter DAI, and the total DAI is updated across the two multicast services 421 and 422. For the same multicast service, such as multicast service 421, the counter DAI 431 for PDSCH transmission 401 and the counter DAI 432 for PDSCH transmission 402 are updated in time order. The presence of the total DAI in a multicast DCI format may be dependent on the number of configured G-RNTIs. For example, in the case that only a single G-RNTI is configured, the multicast DCI format may not include the total DAI; in the case that two or more G-RNTIs are configured, the multicast DCI format may include the total DAI.

In some embodiments, a size of the HARQ-ACK feedback combination is determined based on a last total DAI value among total DAI values associated with the plurality of PDSCH transmissions. For example, in the example shown in FIG. 4, the size of the HARQ-ACK feedback combination is determined based on a last total DAI value, i.e., total DAI 444, which is 4.

In some embodiments, the HARQ-ACK feedback combination includes a number of sub-combinations, each sub-combination includes one or more HARQ-ACK information bits for PDSCH transmission(s) associated with a same multicast service, and the number of sub-combinations is determined based on the number of G-RNTIs associated with the multicast service(s) associated with the plurality of PDSCH transmissions and the sub-combinations are ordered based on G-RNTI value(s) associated with respective multicast service(s).

In some embodiments, the UE may align a total number of HARQ-ACK information bits for a sub-combination to a configured size by performing HARQ-ACK padding or HARQ-ACK bundling. For example, the UE may perform HARQ-ACK padding by padding one or more NACK bits, and may perform HARQ-ACK bundling by performing AND operations.

In some embodiments, the PUCCH resource is determined based on a mapping table (e.g., any of Tables 2, 3, and 4A-4D) including a relation between the HARQ-ACK feedback combination and a PUCCH resource index associated with the PUCCH resource.

In some embodiments, PUCCH resources associated with different PUCCH resource indexes in the mapping table are orthogonal to each other.

In some embodiments, a total number of PUCCH resources indicated by the mapping table is determined based on at least one of the following: a maximum number of HARQ-ACK information bits included in a HARQ-ACK feedback combination; a PUCCH format; or a total number of bits carried by the PUCCH format.

In some embodiments, the PUCCH resource includes a PUCCH sequence in the case that the PUCCH transmission is performed with a first PUCCH format, or one or two bits are transmitted on the PUCCH resource in the case that the PUCCH transmission is performed with a second PUCCH format.

In some embodiments, the UE may perform spatial bundling to generate a single HARQ-ACK information bit for a PDSCH transmission of the plurality of PDSCH transmissions in response to two code words being carried on the PDSCH transmission.

In some embodiments, the PUCCH resource is determined from a set of PUCCH resources configured by RRC signaling.

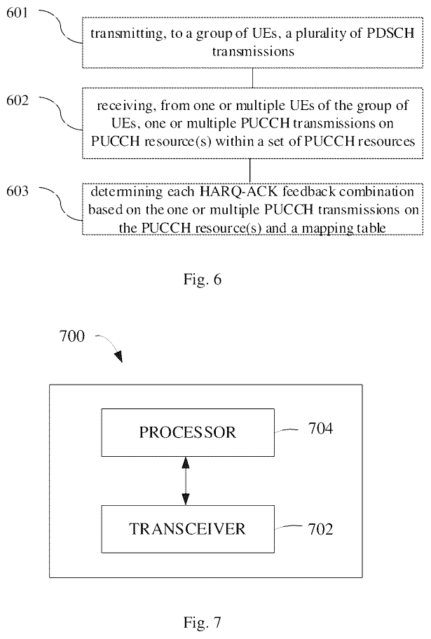

FIG. 6 illustrates a flowchart of an exemplary method performed by a BS (e.g., BS 102 in FIG. 1) for NACK-only based HARQ-ACK feedback according to some embodiments of the present disclosure. Details described in all of the foregoing embodiments of the present disclosure are applicable for the embodiments shown in FIG. 6.

In operation 601, the BS may transmit, to a group of UEs, a plurality of PDSCH transmissions. In operation 602, the BS may receive, from one or multiple UEs of the group of UEs, one or multiple PUCCH transmissions on PUCCH resource(s) within a set of PUCCH resources, wherein each PUCCH transmission carries a HARQ-ACK feedback combination for the plurality of PDSCH transmissions.

In operation 603, the BS may determine each HARQ-ACK feedback combination based on the one or multiple PUCCH transmissions on the PUCCH resource(s) and a mapping table, wherein the mapping table defines relations between a set of HARQ-ACK feedback combinations and the set of PUCCH resources.

FIG. 7 illustrates a simplified block diagram of an exemplary apparatus 700 according to some embodiments of the present disclosure.

As shown in FIG. 7, the apparatus 700 may include at least one processor 704 and at least one transceiver 702 coupled to the processor 704. The apparatus 700 may be or include at least part of a UE or a BS.

Although in this figure, elements such as the transceiver 702 and the processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of the UE described with respect to any of FIGS. 1-6. In some embodiments of the present disclosure, the apparatus 700 may be a BS. The transceiver 702 and the processor 704 may interact with each other so as to perform the operations of the BS described with respect to any of FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement any method performed by the UE as described above. For example, the computer-executable instructions, when executed, may cause the processor 704 interacting with the transceiver 702 to perform the operations of the UE described with respect to any of FIGS. 1-6.

In some embodiments of the present disclosure, the non-transitory computer-readable medium may have stored thereon computer-executable instructions to cause the processor 704 to implement any method performed by the BS as described above. For example, the computer-executable instructions, when executed, may cause the processor 704 interacting with the transceiver 702 to perform the operations of the BS described with respect to any of FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions, unless a relationship or order is explicitly specified. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a plurality of physical downlink shared channel (PDSCH) transmissions;
determine a hybrid automatic repeat request (HARQ) acknowledgement (ACK) feedback combination including HARQ-ACK information bits for the plurality of PDSCH transmissions, wherein each HARQ-ACK information bit is associated with one of the plurality of PDSCH transmissions;
determine a physical uplink control channel (PUCCH) resource based on the HARQ-ACK feedback combination in response to at least one PDSCH transmission of the plurality of PDSCH transmissions being incorrectly decoded; and
perform a PUCCH transmission with the PUCCH resource.

2. The UE of claim 1, wherein each PDSCH transmission of the plurality of PDSCH transmissions is associated with a HARQ process number (HPN), and the HARQ-ACK information bits included in the HARQ-ACK feedback combination is ordered based on associated HPNs of respective PDSCH transmissions.

3. The UE of claim 1, wherein each PDSCH transmission of the plurality of PDSCH transmissions is associated with a counter downlink assignment indicator (DAI) value which is updated across one or more multicast services associated with the plurality of PDSCH transmissions, and the HARQ-ACK information bits included in the HARQ-ACK feedback combination are ordered based on the associated counter DAI values of respective PDSCH transmissions.

4. The UE of claim 3, wherein the counter DAI value is updated in an order of one or more group-common radio network temporary identifier (G-RNTI) values associated with the one or more multicast services and in a time order for a same multicast service.

5. The UE of claim 1, wherein each PDSCH transmission of the plurality of PDSCH transmissions is associated with a total downlink assignment indicator (DAI) value which is updated across one or more multicast services associated with the plurality of PDSCH transmissions and a counter DAI value which is updated per multicast service, and the HARQ-ACK information bits included in the HARQ-ACK feedback combination are ordered based on one or more group-common radio network temporary identifier (G-RNTI) values associated with the one or more multicast services and the associated counter DAI values of respective PDSCH transmissions for a same multicast service.

6. The UE of claim 5, wherein the total DAI value is updated in order of the one or more G-RNTI values associated with the one or more multicast services and in a time order for a same multicast service.

7. The UE of claim 5, wherein a size of the HARQ-ACK feedback combination is determined based on a last total DAI value among total DAI values associated with the plurality of PDSCH transmissions.

8. The UE of claim 1, wherein the HARQ-ACK feedback combination includes a number of sub-combinations, each sub-combination includes one or more HARQ-ACK information bits for one or more of the PDSCH transmissions associated with a same multicast service, and the number of sub-combinations is determined based on a number of group-common radio network temporary identifiers (G-RNTIs) associated with one or more multicast services associated with the plurality of PDSCH transmissions and the sub-combinations are ordered based on one or more G-RNTI values associated with respective one or more multicast services.

9. The UE of claim 8, wherein the at least one processor is configured to cause the UE to align a total number of HARQ-ACK information bits for a sub-combination to a configured size by performing HARQ-ACK padding or HARQ-ACK bundling.

10. The UE of claim 1, wherein the PUCCH resource is determined based on a mapping table including a relation between the HARQ-ACK feedback combination and a PUCCH resource index associated with the PUCCH resource.

11. The UE of claim 10, wherein a total number of PUCCH resources indicated by the mapping table is determined based on at least one of:
a maximum number of HARQ-ACK information bits included in a HARQ-ACK feedback combination;
a PUCCH format; or
a total number of bits carried by the PUCCH format.

12. The UE of claim 1, wherein the PUCCH resource includes a PUCCH sequence if the PUCCH transmission is performed with a first PUCCH format, or one or two bits are transmitted on the PUCCH resource if the PUCCH transmission is performed with a second PUCCH format.

13. The UE of claim 1, wherein the at least one processor is configured to cause the UE to perform spatial bundling to generate a single HARQ-ACK information bit for a PDSCH transmission of the plurality of PDSCH transmissions in response to two code words being carried on the PDSCH transmission.

14. A base station (BS) for wireless communication, comprising:
at least one memory; and
at least one processor coupled with the at least one memory and configured to cause the BS to:
transmit, to a group of user equipments (UEs), a plurality of physical downlink shared channel (PDSCH) transmissions;
receive, from one or multiple UEs of the group of UEs, one or multiple physical uplink control channel (PUCCH) transmissions on one or more PUCCH resources within a set of PUCCH resources, wherein each PUCCH transmission carries a hybrid automatic repeat request (HARQ) acknowledgement (ACK) feedback combination for the plurality of PDSCH transmissions; and
determine each HARQ-ACK feedback combination based on the one or multiple PUCCH transmissions on the one or more PUCCH resources and a mapping table, wherein the mapping table defines relations between a set of HARQ-ACK feedback combinations and the set of PUCCH resources.

15. A method performed by a user equipment (UE), the method comprising:
receiving a plurality of physical downlink shared channel (PDSCH) transmissions;
determining a hybrid automatic repeat request (HARQ) acknowledgement (ACK) feedback combination including HARQ-ACK information bits for the plurality of PDSCH transmissions, wherein each HARQ-ACK information bit is associated with one of the plurality of PDSCH transmissions;
determining a physical uplink control channel (PUCCH) resource based on the HARQ-ACK feedback combination in response to at least one PDSCH transmission of the plurality of PDSCH transmissions being incorrectly decoded; and
performing a PUCCH transmission with the PUCCH resource.

16. A processor for wireless communication, comprising:
at least one controller coupled with at least one memory and configured to cause the processor to:
receive a plurality of physical downlink shared channel (PDSCH) transmissions;
determine a hybrid automatic repeat request (HARQ) acknowledgement (ACK) feedback combination including HARQ-ACK information bits for the plurality of PDSCH transmissions, wherein each HARQ-ACK information bit is associated with one of the plurality of PDSCH transmissions;
determine a physical uplink control channel (PUCCH) resource based on the HARQ-ACK feedback combination in response to at least one PDSCH transmission of the plurality of PDSCH transmissions being incorrectly decoded; and
perform a PUCCH transmission with the PUCCH resource.

17. The processor of claim 16, wherein each PDSCH transmission of the plurality of PDSCH transmissions is associated with a counter downlink assignment indicator (DAI) value which is updated across one or more multicast services associated with the plurality of PDSCH transmissions, and the HARQ-ACK information bits included in the HARQ-ACK feedback combination are ordered based on the associated counter DAI values of respective PDSCH transmissions.

18. The processor of claim 17, wherein the counter DAI value is updated in an order of one or more group-common radio network temporary identifier (G-RNTI) values associated with the one or more multicast services and in a time order for a same multicast service.

19. The processor of claim 16, wherein the PUCCH resource is determined based on a mapping table including a relation between the HARQ-ACK feedback combination and a PUCCH resource index associated with the PUCCH resource.

20. The processor of claim 16, wherein the at least one controller is configured to cause the processor to perform spatial bundling to generate a single HARQ-ACK information bit for a PDSCH transmission of the plurality of PDSCH transmissions in response to two code words being carried on the PDSCH transmission.
